(19) United States
(12) Patent Application Publication
(10) Pub. No.: US 2018/0108985 A1
(43) Pub. Date: Apr. 19, 2018

(54) ANTENNA ARRAY AND NETWORK DEVICE

(71) Applicant: HUAWEI TECHNOLOGIES CO., LTD., Shenzhen (CN)

(72) Inventors: Qiang WANG, Chengdu (CN); Yang GENG, Shanghai (CN); Long SHEN, Shanghai (CN); Jianping ZHAO, Shanghai (CN)

(21) Appl. No.: 15/843,172

(22) Filed: Dec. 15, 2017

Related U.S. Application Data
(63) Continuation of application No. PCT/CN2016/087183, filed on Jun. 25, 2016.

(30) Foreign Application Priority Data
Jun. 30, 2015 (CN) 201510374908.3

(51) Int. Cl. H01Q 1/52; H01Q 1/12; H01Q 5/307

(52) U.S. Cl. CPC H01Q 1/523; H01Q 5/307; H01Q 1/525; H01Q 1/1264

(57) ABSTRACT

An antenna array, including at least two antenna bays. Operating frequency bands of all of the at least two antenna bays are the same, each antenna bay includes at least one transmit channel or receive channel, and each antenna bay transmits data in a co-frequency co-time full duplex manner. Alternatively, operating frequency bands of two adjacent antenna bays of the at least two antenna bays are adjacent frequency bands or are separated by one or two frequency bands, each antenna bay includes at least one receive channel and at least one transmit channel, and each antenna bay transmits data in an asynchronous manner. An angle value between a line connecting center points of any two adjacent antenna bays of the at least two antenna bays and a horizontal line is acute. By using the present invention, isolation between antenna bays of the antenna array is increased.

### CROSS-REFERENCE TO RELATED APPLICATIONS

This application is a continuation of International Application No. PCT/CN2016/087183, filed on Jun. 25, 2016, which claims priority to Chinese Patent Application No. 201510374908.3, filed on Jun. 30, 2015. The disclosure of the aforementioned applications are hereby incorporated by reference in its entirety.

### TECHNICAL FIELD

The present invention relates to the antenna field, and in particular, to an antenna array and a network device.

### BACKGROUND

With rapid development of wireless communications technologies, wireless interconnection of personal terminals becomes rapidly popular, and wireless communication has become an indispensable interaction means for individuals and society. However, existing wireless spectrum resources are nearly exhausted, and demands of wireless communication services for spectrum resources are exponentially rising. In 2011, Rice University in the United States first developed a full duplex technology. A wireless communications device can simultaneously transmit and receive a radio signal co-frequency co-time, and can theoretically double spectrum efficiency compared with existing time division duplex (TDD) and frequency division duplex (FDD) systems. Since then, the full-duplex technology has attracted more attention from the industry, and has become a research focus in the wireless communications field.

Compared with a conventional base station communications system, transmitter-receiver isolation in a full duplex system is an especially important indicator. If transmitter-receiver isolation of the system is not well implemented, a receive channel cannot work properly when a transmit channel transmits data, or self-excitation of the receive channel may be caused. In a case of high power, even a front-end amplifier of the receive channel may be damaged. The full duplex system mainly includes two parts: a radio frequency module and an antenna. Transmitter-receiver isolation in the full duplex system mainly involves isolation of the antenna and designs of a receive channel and a transmit channel in the radio frequency module. Therefore, how to improve isolation between a receive antenna and a transmit antenna has become a popular research currently.

### SUMMARY

In embodiments of the present invention provide an antenna array and a network device, to improve isolation between antenna bays of an antenna array.

To resolve the technical problem, a first aspect of the embodiments of the present invention provides an antenna array, including at least two antenna bays, where operating frequency bands of all of the at least two antenna bays are the same, each antenna bay includes at least one transmit channel or receive channel, and each antenna bay transmits data in a co-frequency co-time full duplex manner; or

operating frequency bands of two adjacent antenna bays of the at least two antenna bays are adjacent frequency bands or are separated by one frequency band or two frequency bands, each antenna bay includes at least one receive channel and at least one transmit channel, and each antenna bay transmits data in an asynchronous manner, where

an angle value of an acute included angle between a line connecting center points of any two adjacent antenna bays of the at least two antenna bays and a horizontal line is θ, where 30≤θ≤60.

With reference to the first aspect, in a first possible implementation, all of the at least two antenna bays are on a same plane.

With reference to the first possible implementation of the first aspect, in a second possible implementation, in a rectangle formed by two adjacent antenna bays, the two adjacent antenna bays are disposed at two ends of one diagonal of the rectangle, and the other diagonal of the rectangle is empty.

With reference to the first or the second possible implementation of the first aspect, in a third possible implementation, center points of all of the at least two antenna bays are on a same straight line.

With reference to the first aspect, in a fourth possible implementation, each of the at least two antenna bays includes several radiating elements, metal walls are disposed around each radiating element, and a height of the metal wall is H=h*(100%±10%), where his a height of the radiating element.

With reference to the fourth possible implementation of the first aspect, in a fifth possible implementation, a circular-arc back cavity, a parabolic back cavity, or a hyperbolic back cavity is disposed below the radiating elements of each of the at least two antenna bays.

With reference to the fourth or the fifth possible implementation of the first aspect, in a sixth possible implementation, two symmetrical assembly slots are disposed on each vertical plane of the metal walls.

With reference to the sixth possible implementation of the first aspect, in a seventh possible implementation, each of the at least two antenna bays includes radiating elements of M rows and N columns, and when a row spacing and a column spacing of the radiating elements of the antenna bay are not equal, an isolating bar is disposed in the middle of a larger spacing.

With reference to the first aspect, in an eighth possible implementation, a fully enclosed or semi-enclosed fence is disposed around each of the at least two antenna bays, and a material of the fence includes an EBG, metal, an electromagnetic wave absorber, or a left-handed material.

With reference to the first aspect, in a ninth possible implementation, the at least two antenna bays share a same radome, and isolating bars of different heights are disposed inside the radome.

With reference to the first aspect, in a tenth possible implementation, the at least two antenna bays are installed on a ground plate, a surface of the ground plate is provided with an isolating groove, the isolating groove is located between two adjacent antenna bays, and the isolating groove is disposed horizontally, vertically, or obliquely.

With reference to the first aspect, in an eleventh possible implementation, an isolating wall is disposed between the two adjacent antenna bays, the isolating wall is arranged horizontally, vertically, or obliquely, and a material of the isolating wall includes an EBG, metal, an electromagnetic wave absorber, or a left-handed material.

With reference to the first aspect, in a twelfth possible implementation, the antenna bay of the antenna array is a dual-polarized antenna.

A second aspect of the embodiments of the present invention discloses an antenna array, including at least 4+2n antenna bays, where n≥0 and n is an integer, and the 4+2n antenna bays form a matrix of two rows and n+2 columns; and

each of the at least 4+2n antenna bays includes at least one transmit channel or at least one receive channel, operating frequency bands of two antenna bays at two ends of a diagonal are the same, and the two antenna bays at the two ends of the diagonal transmit data in a co-frequency co-time full duplex manner; or each of the at least 4+2n antenna bays includes at least one transmitchannel and at least one receive channel, operating frequency bands of two antenna bays at two ends of a diagonal are adjacent frequency bands or are separated by one frequency band or two frequency bands, and the two antenna bays at the two ends of the diagonal transmit data in an asynchronous manner, where

an angle value of an acute included angle between a line connecting center points of the two antenna bays at the two ends of the diagonal and a horizontal line is θ, where 30≤θ0≤60.

With reference to the second aspect, in a first possible implementation, all of the at least 4+2n antenna bays are on a same plane.

With reference to the second aspect, in a second possible implementation, each of the at least 4+2n antenna bays includes several radiating elements, metal walls are disposed around each radiating element, and a height of the metal wall is H=h*(100%±10%), where h is a height of the radiating element.

With reference to the second possible implementation of the second aspect, in a third possible implementation, a circular-arc back cavity, a parabolic back cavity, or a hyperbolic back cavity is disposed below the radiating elements of each of the at least 4+2n antenna bays.

With reference to the second or the third possible implementation of the second aspect, in a fourth possible implementation, two symmetrical assembly slots are disposed on each vertical plane of the metal walls.

With reference to the second possible implementation of the second aspect, in a fifth possible implementation, each of the at least 4+2n antenna bays includes radiating elements of M rows and N columns, and when a row spacing and a column spacing of the radiating elements of the antenna bay are not equal, an isolating bar is disposed in the middle of a larger spacing.

With reference to the second aspect, in a sixth possible implementation, a fully enclosed or semi-enclosed fence is disposed around each of the at least 4+2n antenna bays, and a material of the fence includes an EBG, metal, an electromagnetic wave absorber, or a left-handed material.

With reference to the second aspect, in a seventh possible implementation, the at least 4+2n antenna bays share a same radome, and isolating bars of different heights are disposed inside the radome.

With reference to the second aspect, in an eighth possible implementation, the at least 4+2n antenna bays are installed on a ground plate, a surface of the ground plate is provided with an isolating groove, the isolating groove is located between two antenna bays at two ends of a diagonal, and the isolating groove is disposed horizontally, vertically, or obliquely.

With reference to the second aspect, in a ninth possible implementation, an isolating wall is disposed between two antenna bays at two ends of a diagonal, the isolating wall is arranged horizontally, vertically, or obliquely, and a material of the isolating wall includes an EBG, metal, an electromagnetic wave absorber, or a left-handed material.

With reference to the second aspect, in a tenth possible implementation, the antenna bay of the antenna array is a dual-polarized antenna.

A third aspect of the embodiments of the present invention provides a network device, including the antenna array according to any one of the foregoing aspects and implementations.

Implementation of the embodiments of the present invention brings at least the following beneficial effects:

By limiting the angle value of the acute included angle between the line connecting the center points of the two adjacent antenna bays and the horizontal line to 30 to 60, isolation between the antenna bays can be effectively increased, and interference in the antenna array can be reduced. With reference to technical features of other possible implementations, isolation between the antenna bays can be further increased.

### BRIEF DESCRIPTION OF DRAWINGS

To describe the technical solutions in the embodiments of the present invention more clearly, the following briefly describes the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic structural diagram of an antenna array according to a first embodiment of the present invention;

FIG. 2 is a schematic structural diagram of an antenna array according to a second embodiment of the present invention;

FIG. 3 is a schematic structural diagram of an antenna array according to a third embodiment of the present invention;

FIG. 4 is a schematic structural diagram of an antenna array according to a fourth embodiment of the present invention;

FIG. 5 is a schematic structural diagram of an antenna array according to a fifth embodiment of the present invention;

FIG. 6 is a top view of a radiating element according to an embodiment of the present invention;

FIG. 7 is a side view of a radiating element according to an embodiment of the present invention;

FIG. 8a is a schematic structural diagram of an antenna array according to a sixth embodiment of the present invention;

FIG. 8b is a schematic distribution diagram of isolation between antenna bays in

FIG. 8a;

FIG. 9 is a schematic structural diagram of an antenna array according to a seventh embodiment of the present invention; and

FIG. 10 is a schematic diagram of an operating frequency band of an antenna bay according to an embodiment of the present invention.

### DESCRIPTION OF EMBODIMENTS

The following clearly describes the technical solutions in the embodiments of the present invention with reference to the accompanying drawings in the embodiments of the present invention. Apparently, the described embodiments are merely some but not all of the embodiments of the present invention. All other embodiments obtained by a person of ordinary skill in the art based on the embodiments of the present invention without creative efforts shall fall within the protection scope of the present invention.

An embodiment of the present invention provides a schematic structural diagram of an antenna array. The antenna array includes at least two antenna bays. Operating frequency bands of all of the at least two antenna bays are the same, each antenna bay includes at least one transmit channel or receive channel, and each antenna bay transmits data in a co-frequency co-time full duplex manner. Alternatively, operating frequency bands of all of the at least two antenna bays are different, each antenna bay includes at least one transmit channel and at least one transmit channel, and each antenna bay transmits data in an asynchronous manner. An angle value of an acute included angle between a line connecting center points of any two adjacent antenna bays of the at least two antenna bays and a horizontal line is limited to 30 degrees to 60 degrees. Two adjacent antenna bays form a group, and angle values of included angles (acute angles) between lines connecting center points of antenna bays in different groups and the horizontal line may be equal or unequal, but all fall within a value range of 30 degrees to 60 degrees. Arranging the antenna bays of the antenna array in the foregoing manner can increase isolation between antenna bays, and reduce interference between the antenna bays. A shape of the antenna bay may be a regular geometric figure. For example, the antenna bay is in a shape of a rectangle, a circle, a triangle. A center point of the antenna bay is a geometric center point of the antenna bay. For example, a center point of a rectangle is a cross point of diagonals, a center point of a circle is a center of the circle, and a center point of a triangle is a circle center of a circumcircle of the triangle. In a scenario in which a co-frequency co-time full duplex manner is used, there is tremendous interference between two adjacent antenna bays, and by using the antenna bay arrangement mode in this embodiment of the present invention, isolation between the two adjacent antenna bays can be effectively increased, and mutual interference can be reduced. In a scenario in which an asynchronous inter-frequency manner is used, for two adjacent antenna bays, there may be a case in which one antenna bay is receiving data and the other antenna bay is transmitting data. This causes out-of-band leakage, and quite large interference is caused between the two antenna bays. Especially when operating frequency bands of the two antenna bays are adjacent frequency bands or are separated by one frequency band or two frequency bands, maximum interference is reached. By using the antenna bay arrangement mode in this embodiment of the present invention, isolation between the two adjacent antenna bays can be effectively increased, and mutual interference can be reduced.

An embodiment of the present invention provides another antenna array, including at least 4+2n antenna bays, where n≥0 and n is an integer. The at least 4+2n antenna bays form a matrix of two rows and n+2 columns. For example, when n=1, the at least 4+2n antenna bays form a matrix of two rows and three columns.

Each of the at least 4+2n antenna arrays includes at least one transmit channel or at least one receive channel, that is, each antenna bay can either transmit data or receive data only. A rectangle formed by four adjacent antenna bays is used for example. Operating frequency bands of two antenna bays at two ends of a diagonal are the same, and the two antenna bays at the two ends of the diagonal transmit data in a co-frequency co-time full duplex manner. The rectangle has two diagonals. Operating frequency bands of the antenna bays at ends of the two diagonals may be the same or may be different. Because the two antenna bays at the two ends of the diagonal transmit data in a co-frequency co-time full duplex manner, quite large interference is generated between the two antenna bays. By limiting an angle value of an acute included angle between a line connecting center points of the two antenna bays at the two ends of the diagonal and a horizontal line to 30 to 60, isolation between the two antenna bays at the two ends of the diagonal can be effectively increased, and interference between the two antenna bays can be reduced. Alternatively, each of the at least 4+2n antenna bays includes at least one transmitchannel or at least one receive channel, and operating frequency bands of two antenna bays at two ends of a diagonal are adjacent frequency bands or are separated by one frequency band or two frequency bands. A rectangle formed by four antenna bays is used for example. The rectangle has two diagonals, and limiting conditions of operating frequency bands of two groups of antenna bays at ends of the two diagonals may be the same or may be different. For example, two operating frequency bands of antenna bays at two ends of one diagonal are adjacent frequency bands, and two operating frequency bands of antenna bays at two ends of the other diagonal are separated by one frequency band. In a scenario in which an asynchronous inter-frequency manner is used, for two antenna bays at two ends of a diagonal, there may be a case in which one antenna bay is receiving data and the other antenna bay is transmitting data. This causes out-of-band leakage. In addition, because operating frequency bands of the two antenna bays are adjacent frequency bands or are separated by one frequency band or two frequency bands, tremendous interference is caused between the two antenna bays. By using the antenna bay arrangement mode in this embodiment of the present invention, an angle value of an acute included angle between a line connecting center points of the two antenna bays at the two ends of the diagonal and a horizontal line is limited to 30 degrees to 60 degrees, isolation between the two antenna bays at the two ends of the diagonal can be effectively increased, and mutual interference can be reduced.

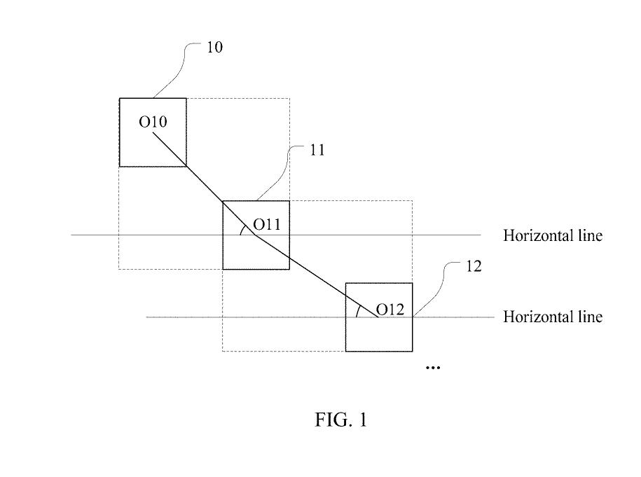

Referring to FIG. 1, FIG. 1 is a schematic structural diagram of an antenna array according to a first embodiment of the present invention. In this embodiment of the present invention, the antenna array includes an antenna bay 10, an antenna bay 11, an antenna bay 12, . . . . All antenna bays of the antenna array are on a same plane. A shape of the antenna bay is a rectangle, and two adjacent antenna bays indicate antenna bays that are located close to each other. The antenna bay 10 and the antenna bay 11 are two adjacent antenna bays, and the antenna bay 11 and the antenna bay 12 are two adjacent antenna bays. An area of a rectangle (dashed box) formed by outer vertices of the antenna bay 10 and the antenna bay 11 is S1, that is, the antenna bay 10 and the antenna bay 11 move within the rectangle with the area S1. An area of a rectangle (dashed box) formed by outer vertices of the antenna bay 11 and the antenna bay 12 is S2, that is, the antenna bay 11 and the antenna bay 12 move within the rectangle with the area S2. An area of a rectangle formed by two adjacent antenna bays may be the same as or different from that of a rectangle formed by another two adjacent antenna bays. A center point of the antenna bay 10 is O10, and a center point of the antenna bay 11 is O11. An angle value of an included angle (acute angle) between a line O10011 connecting the center points of the antenna bay 10 and the antenna bay 11 and a horizontal line is θ1, where 30≤θ1≤60. A center point of the antenna bay 12 is O12. An angle value of an included angle (acute angle) between a line O11012 connecting the center points of the antenna bay 11 and the antenna bay 12 and the horizontal line is θ2, where 30≤θ2≤60. It can be learned from FIG. 1 that a current antenna bay is at lower right of an antenna bay that is adjacent to the current antenna bay and whose number precedes that of the current antenna bay, and center points of the antenna bays of the antenna array may not be on a same straight line or may be on a same straight line.

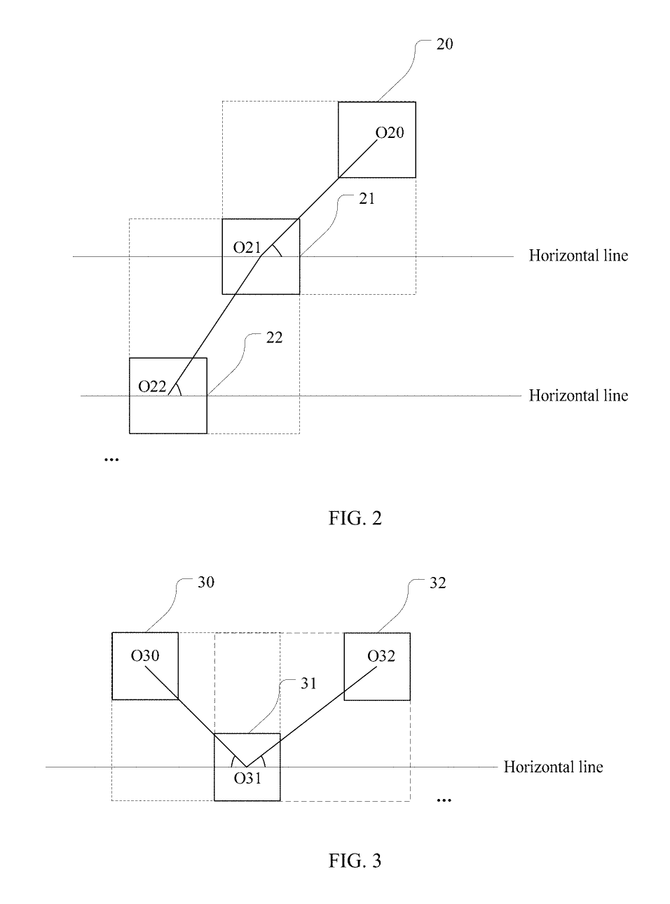

Referring to FIG. 2, FIG. 2 is a schematic structural diagram of an antenna array according to a second embodiment of the present invention. In this embodiment of the present invention, the antenna array includes an antenna bay 20, an antenna bay 21, an antenna bay 22, . . . . A center point of the antenna bay 20 is O20, a center point of the antenna bay 21 is O21, and a center point of the antenna bay 22 is O22. The antenna bay 20 and the antenna bay 21 are adjacent to each other, and the antenna bay 21 and the antenna bay 22 are adjacent to each other. An area of a rectangle (dashed box) formed by the antenna bay 20 and the antenna bay 21 is S1, that is, the antenna bay 20 and the antenna bay 21 can move only within the rectangle with the area S1. An angle value of an included angle (acute angle) between a line O20021 connecting the center points of the antenna bay 20 and the antenna bay 21 and a horizontal line is θ1, where 30≤θ1≤60. An area of a rectangle (dashed box) formed by the antenna bay 21 and the antenna bay 22 is S2, that is, the antenna bay 21 and the antenna bay 22 move within the rectangle with the area S2. An angle value of an included angle (acute angle) between a line O21022 connecting the center points of the antenna bay 21 and the antenna bay 22 and the horizontal line is θ2, where 30≤θ2≤60. In FIG. 2, an arrangement feature of the antenna bays is that an antenna bay is at lower left of an antenna bay that is adjacent to the antenna bay and whose number precedes that of the antenna bay, and center points of the antenna bays may be on a same straight line or may be not on a same straight line.

Referring to FIG. 3, FIG. 3 is a schematic structural diagram of an antenna array according to a third embodiment of the present invention. In this embodiment of the present invention, the antenna array includes an antenna bay 30, an antenna bay 31, an antenna bay 32, . . . . The antenna bay 30 and the antenna bay 31 are adjacent to each other, all antenna bays of the antenna array are on a same plane, and the antenna bay 31 and the antenna bay 32 are adjacent to each other. A center point of the antenna bay 30 is O30, and a center point of the antenna bay 31 is O31. An area of a rectangle formed by the antenna bay 30 and the antenna bay 31 is S1, that is, the antenna bay 30 and the antenna bay 31 move within the rectangle with the area S1. An angle value of an included angle (acute angle) between a line O30031 connecting the center points of the antenna bay 30 and the antenna bay 31 and a horizontal line is θ1, where 30≤θ1≤60. An area of a rectangle formed by the antenna bay 31 and the antenna bay 32 is S2, that is, the antenna bay 31 and the antenna bay 32 move within the rectangle with the area S2. An angle value of an included angle (acute angle) between a line connecting the center point of the antenna bay 31 and a center point of the antenna bay 32 and the horizontal line is θ2, where 30≤θ2≤60. In FIG. 3, an arrangement feature of the antenna bays is that a first antenna bay is at upper left, a second antenna bay that is adjacent to the first antenna bay and whose number follows that of the first antenna bay is at lower right, and a third antenna bay that is adjacent to the second antenna bay and whose number follows that of the second antenna bay is at upper right. Other antenna bays are similarly arranged, and an angle value of an included angle between a line connecting center points of two adjacent antenna bays and the horizontal line falls within a range of 30 degrees to 60 degrees.

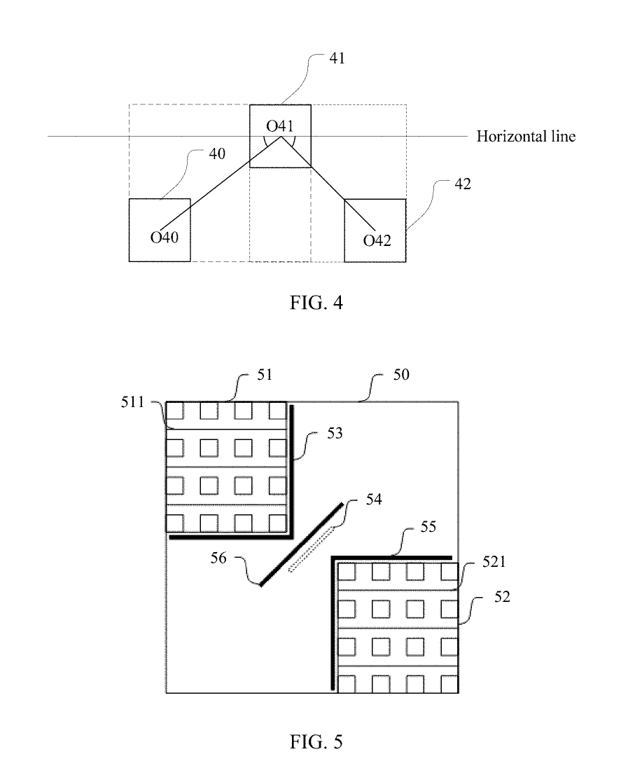

Referring to FIG. 4, FIG. 4 is a schematic structural diagram of an antenna array according to a fourth embodiment of the present invention. In this embodiment of the present invention, the antenna array includes an antenna bay 40, an antenna bay 41, an antenna bay 42, . . . . All antenna bays of the antenna array are on a same plane. The antenna bay 40 and the antenna bay 41 are adjacent to each other, and the antenna bay 41 and the antenna bay 42 are adjacent to each other. A center point of the antenna bay 40 is O40, a center point of the antenna bay 41 is O41, and a center point of the antenna bay 42 is O42. An area of a rectangle formed by the antenna bay 40 and the antenna bay 41 is S1, that is, the antenna bay 40 and the antenna bay 41 move within the rectangle with the area S1. An angle value of an included angle (acute angle) between a line O40041 connecting the center points of the antenna bay 40 and the antenna bay 41 and a horizontal line is θ1, where 30≤θ1≤60. An area of a rectangle formed by the antenna bay 41 and the antenna bay 42 is S2, that is, the antenna bay 41 and the antenna bay 42 move within the rectangle with the area S2. An angle value of an included angle between a line O41042 connecting the center points of the antenna bay 41 and the antenna bay 42 and the horizontal line is θ2, where 30≤θ2≤60. In this embodiment of the present invention, an arrangement feature of the antenna bays is that a first antenna bay is at lower left, a second antenna bay that is adjacent to the first antenna bay and whose number follows that of the first antenna bay is at upper right, and a third antenna bay that is adjacent to the second antenna bay and whose number follows that of the second antenna bay is at lower right. Other antenna bays are similarly arranged, and an angle value of an included angle between a line connecting center points of two adjacent antenna bays and the horizontal line falls within a range of 30 degrees to 60 degrees.

It should be noted that, antenna bays of an antenna array may not be arranged according to the rules in FIG. 1 to FIG. 4, provided that an angle value of an included angle between a line connecting center points of adjacent antenna bays and the horizontal line falls within 30 degrees to 60 degrees.

Optionally, all of at least two antenna bays are on a same plane, that is, the antenna bays are planar antennas, and all the antenna bays are on a same plane. It can be understood that, that the antenna bays are on a same plane does not mean that they are on an absolute plane. When height differences of the antenna bays fall within an allowable error range, it can still be considered that the antenna bays are on a same plane. An error refers to a ratio of an antenna bay height difference to an antenna bay height. For example, the allowable error range is 5%, 10%, 15%, 20%, or the like.

Optionally, in a rectangle formed by two adjacent antenna bays, the two adjacent antenna bays are disposed at two ends of one diagonal of the rectangle, and the other diagonal of the rectangle is empty.

Specifically, the two adjacent antenna bays form the rectangle, a line connecting two adjacent center points is a part of the diagonal of the rectangle. A rectangle has two diagonals, in this embodiment of the present invention, the other diagonal is empty, and no antenna bay is disposed at two ends of the other diagonal, as shown in FIG. 1 to FIG. 4.

Optionally, center points of all the antenna bays of the antenna array are on a same straight line. That is, an angle value of an included angle between a line connecting center points of any two adjacent antenna bays of the antenna array and the horizontal line is equal to that between a line connecting center points of another two adjacent antenna bays and the horizontal line. For example, the arrangement modes in FIG. 1 and FIG. 2 meet the following: θ1=θ2= . . . =θn.

Optionally, the antenna bay includes radiating elements of N rows and M columns. The radiating element may be a die-cast dipole, a laminated element, an air microstrip antenna, or the like. Metal walls are disposed around the radiating element, and a height of the metal wall is equal to (100%±10%) of a height of the radiating element.

Optionally, when a row spacing and a column spacing of the radiating elements are not equal, an isolating bar is disposed in the middle of a larger spacing.

Optionally, the radiating element of the antenna bay is disposed inside a cavity. The cavity may be a circular-arc cavity, a parabolic cavity, a hyperbolic cavity, or the like, to enhance secondary lobe performance of the antenna bay, and increase isolation between antenna bays.

Optionally, a fence is disposed around each antenna bay, and the fence is fully enclosed or semi-enclosed. If the fence is semi-enclosed, the fence may be disposed along two adjacent sides of the antenna bay. If the fence is fully-enclosed, the fence is disposed around all four sides of the antenna bay. A material of the fence includes an electromagnetic band gap structure EBG, a metal, an electromagnetic wave absorber, a left-handed material, or the like.

Optionally, an isolating wall is disposed between the two adjacent antenna bays. The isolating wall is arranged horizontally, vertically, or obliquely. A material of the isolating wall includes an EBG, a metal plate, an electromagnetic wave absorber, or a left-handed material.

Optionally, symmetrical assembly slots are disposed in the metal wall of the radiating element, and are configured to assemble a radome.

Optionally, the antenna array is provided with a radome. Isolating bars of different heights are disposed inside the radome, and are configured to prevent propagation of a surface wave and a space wave of each antenna bay, and increase isolation between antenna bays.

Optionally, the antenna array is disposed on a ground plate, and a surface of the ground plate is provided with an isolating groove. The isolating groove is located in the middle of two adjacent antenna bays, and the isolating groove may be arranged horizontally, vertically, or obliquely.

Optionally, the antenna bay of the antenna array is a dual-polarized antenna, that is, each antenna bay includes two antenna channels. In a scenario in which a co-frequency co-time full duplex manner is used, each antenna bay includes two transmit channels or two receive channels. In a scenario in which an asynchronous inter-frequency manner is used, each antenna bay includes one transmit channel and one receive channel.

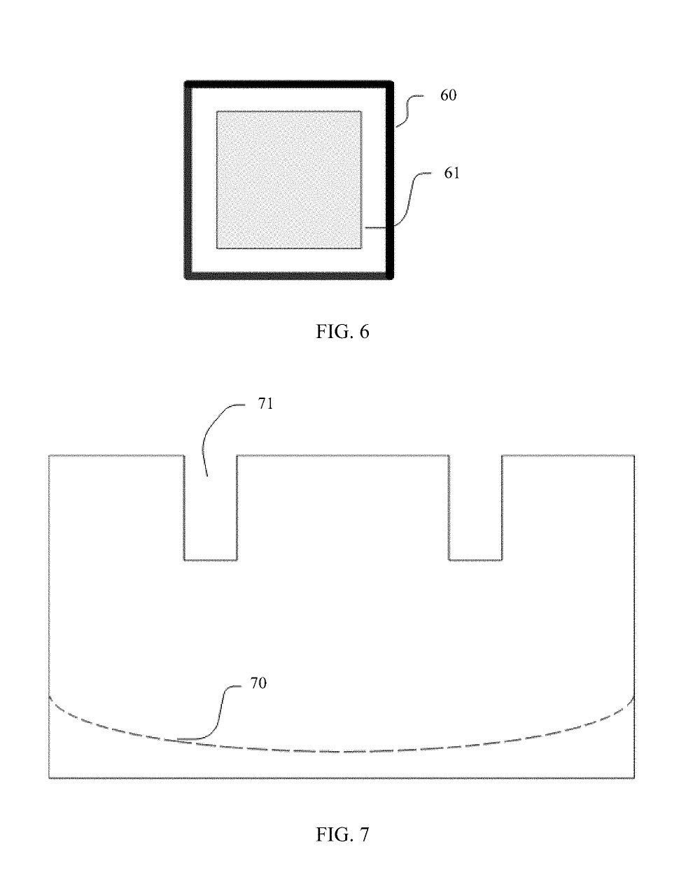

Referring to FIG. 5 to FIG. 7, FIG. 5 to FIG. 7 each are a schematic structural diagram of an antenna array according to an embodiment of the present invention. In this embodiment of the present invention, the antenna array includes two antenna bays: an antenna bay 51 and an antenna bay 52. The antenna bay 51 and the antenna bay 52 are on a same plane and are both in a shape of a rectangle. An area of a rectangle formed by the antenna bay 51 and the antenna bay 52 is a fixed value. An angle value of an acute included angle between a line connecting center points of the two antenna bays and a horizontal line is 30 degrees to 60 degrees. The antenna bay 51 and the antenna bay 52 each include radiating elements of four rows and four columns. It can be learned from the figure that among the radiating elements of the antenna bay 51 and the antenna bay 52, a row spacing is greater than a column spacing, and an isolating bar is disposed in the middle of the row spacing, for example, an isolating bar 511 disposed in the middle of the row spacing of the antenna bay 51, and an isolating bar 521 disposed in the middle of the row spacing of the antenna bay 52. Metal walls are disposed around each radiating element, as shown in a top view of a radiating element in FIG. 6. A radiating element 61 is one of the radiating elements of the antenna bay, and enclosed metal walls 60 are disposed around the radiating element 61. Two symmetrical assembly slots are disposed in each metal wall, and the radiating element is disposed inside a cavity. As shown in a side view of a radiating element in FIG. 7, the radiating element is disposed inside a circular-arc back cavity 70, and four metal walls of the radiating element each are provided with two symmetrical assembly slots 71. The back cavity may be a circular-arc back cavity, a parabolic back cavity, a hyperbolic back cavity, or the like. The antenna bay 51 and the antenna bay 52 are disposed on a ground plate 50, and a material of the ground plate 50 is metal. The antenna bay 51 and the antenna bay 52 are connected to the ground plate 50. An isolating groove 54 is disposed between the antenna bay 51 and the antenna bay 52, and is configured to cut off a couple current between the antenna bay 51 and the antenna bay 52. The isolating groove may be disposed horizontally or vertically, or may be disposed obliquely as in FIG. 5. A fence 53 and a fence 55 are respectively disposed outside the antenna bay 51 and the antenna bay 52. The fence 53 and the fence 55 may be in a fully enclosed structure or a semi-enclosed structure. A material of the fence may be an EBG, a metal plate, an electromagnetic wave absorber, a left-handed material, or the like.

It should be noted that an isolating wall 56 may be disposed between an antenna bay 1 and an antenna bay 2 that are adjacent to each other. The isolating wall 56 may be disposed horizontally, vertically, or obliquely. Preferably, the isolating wall 56 is disposed in the middle of the two adjacent antenna bays and forms a 45-degree angle with a horizontal line. A material of the isolating wall 56 includes an EBG, a metal plate, an electromagnetic wave absorber, a left-handed material, or the like, and no limitation is set thereto in the present invention.

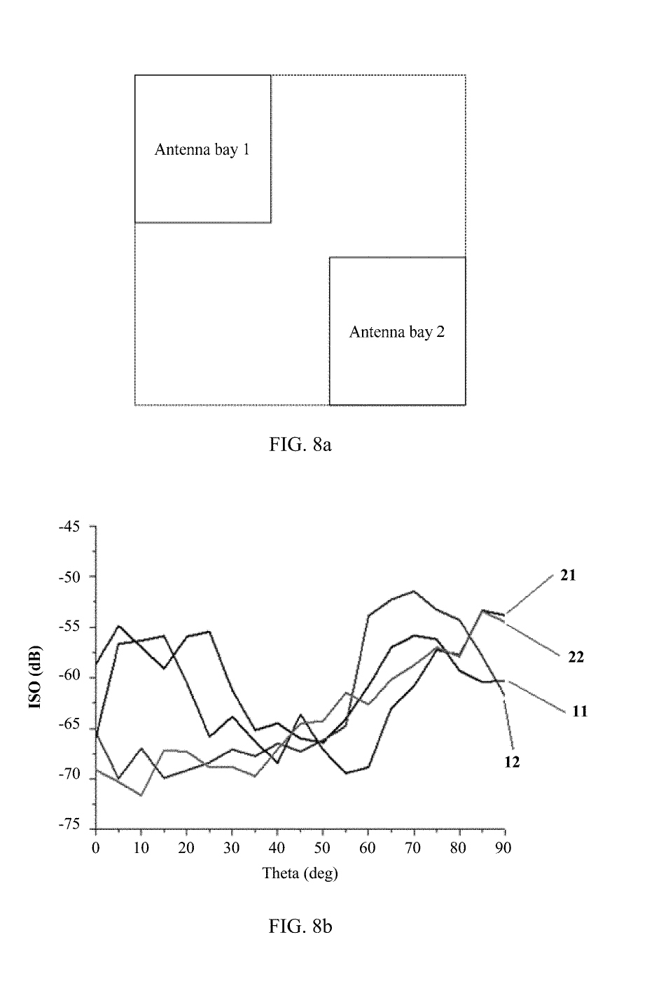

Referring to FIG. 8a, FIG. 8a is a schematic structural diagram of an antenna array according to an embodiment of the present invention. In this embodiment of the present invention, there are two antenna bays. The following describes in detail how a structure of the antenna array in this embodiment of the present invention increases isolation. The antenna array includes an antenna bay 1 and an antenna bay 2. The antenna bay 1 has two antenna channels, and the antenna bay 2 has two antenna channels. An area of a rectangle formed by the antenna bay 1 and the antenna bay 2 is S, and the antenna bay 1 and the antenna bay 2 move within the rectangle with the area S. It is assumed that S=422500 square millimeters, and the following table lists an angle value of an acute included angle θ between a line connecting center points of the antenna bay 1 and the antenna bay 2 and a horizontal line, and values of a length and a width of the rectangle formed by the two antenna bays.

TABLE 1

| θ (deg) | Length (mm) | Width (mm) |
|---|---|---|
| 0.1 | 1984.292898 | 212.9221953 |
| 5 | 1388.267432 | 304.3361749 |
| 10 | 1168.907611 | 361.4485832 |
| 15 | 1040.983117 | 405.8663325 |
| 20 | 952.1609923 | 443.7274825 |
| 25 | 884.2786923 | 477.7905469 |
| 30 | 829.0045276 | 509.6473975 |
| 35 | 781.8442968 | 540.3889262 |
| 40 | 740.0826502 | 570.8821844 |
| 45 | 701.9202462 | 601.9202357 |
| 50 | 666.05602 | 634.3310282 |
| 55 | 631.4567448 | 669.0877934 |
| 60 | 597.2079589 | 707.4587566 |
| 65 | 562.3917095 | 751.2557403 |
| 70 | 525.9477985 | 803.3116617 |
| 75 | 486.4530913 | 868.5318431 |
| 80 | 441.6520065 | 956.635527 |
| 85 | 387.1135066 | 1091.411157 |
| 89.9 | 311.9970029 | 1354.179675 |

In Table 1, θ indicates the included angle between the line connecting the center points of the antenna bay 1 and the antenna bay 2 and the horizontal line, length indicates a long side of the rectangle formed by the antenna bay 1 and the antenna bay 2, and width indicates a short side of the rectangle formed by the antenna bay 1 and the antenna bay 2.

FIG. 8b shows a diagram of a relationship between θ and isolation ISO. The antenna bay 1 includes an antenna channel 1 and an antenna channel 2, and the antenna bay 2 includes an antenna channel 1 and an antenna channel 2. 11 indicates isolation between the antenna channel 1 and the antenna channel 1, 12 indicates isolation between the antenna channel 1 and the antenna channel 2, 21 indicates isolation between the antenna channel 2 and the antenna channel 1, and 22 indicates isolation between the antenna channel 2 and the antenna channel 2. It can be learned from FIG. 8b that when 30≤θ≤60, isolation has a relatively large absolute value, and this indicates that there is desirable isolation between the two antenna bays. In a scenario in which a co-frequency co-time full duplex manner is used, the two antenna channels of the antenna bay 1 are transmit channels or receive channels, the two antenna channels of the antenna bay 2 are transmit channels or receive channels, and channel types of the two antenna bays are different. That is, both channels of one antenna bay are transmit channels, and both channels of the other antenna bay are receive channels. In a scenario in which an asynchronous inter-frequency manner is used, the two antenna channels of the antenna bay 1 are one transmit channel and one receive channel, and the two antenna channels of the antenna bay 2 are also one transmit channel and one receive channel.

The foregoing embodiment is merely an example for description. During a specific implementation process, a corresponding parameter may be changed according to a need to obtain another embodiment, and the another embodiment also falls within the protection scope of the present invention.

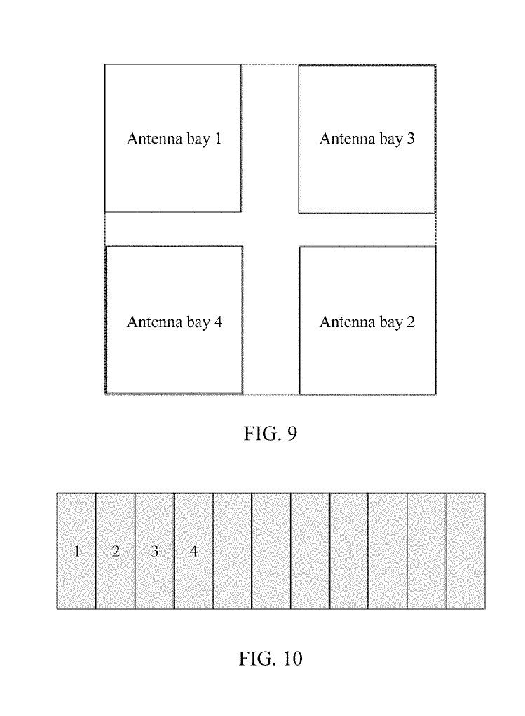

Referring to FIG. 9, FIG. 9 is a schematic structural diagram of an antenna array according to an embodiment of the present invention. The antenna array includes at least 4+2n antenna bays, where n≥0 and n is an integer, and the 4+2n antenna bays form a matrix of two rows and n+2 columns; and

each of the at least 4+2n antenna bays includes at least one transmit channel or at least one receive channel, operating frequency bands of two antenna bays at two ends of a diagonal are the same, and the two antenna bays at the two ends of the diagonal transmit data in a co-frequency co-time full duplex manner; or

each of the at least 4+2n antenna bays includes at least one transmit channel and at least one receive channel, operating frequency bands of two antenna bays at two ends of a diagonal are adjacent frequency bands or are separated by one frequency band or two frequency bands, and the two antenna bays at the two ends of the diagonal transmit data in an asynchronous manner, where

an angle value of an acute included angle between a line connecting center points of the two antenna bays at the two ends of the diagonal and a horizontal line is θ, where 30≤θ≤60.

For example, when the operating frequency bands of the two antenna bays at the two ends of the diagonal are adjacent frequency bands or are separated by one frequency band or two frequency bands, refer to a distribution diagram of operating frequency bands of antenna bays in FIG. 10. In FIG. 10, a frequency band 1 and a frequency band 2 are adjacent frequency bands, the frequency band 1 and a frequency band 3 are separated by one frequency band, and the frequency band 1 and the frequency band 4 are separated by two frequency bands. It can be understood that the frequency band in this embodiment of the present invention represents a subcarrier of a wireless communications system, and each subcarrier has a specific bandwidth.

Optionally, all of the at least 4+2n antenna bays are on a same plane, that is, the antenna bays are planar antennas, and all the antenna bays are on a same plane. It can be understood that, that the antenna bays are on a same plane does not mean that they are on an absolute plane. When height differences of the antenna bays fall within an allowable error range, it can still be considered that the antenna bays are on a same plane. An error refers to a ratio of an antenna bay height difference to an antenna bay height. For example, the allowable error range is 5%, 10%, 15%, 20%, or the like.

Optionally, each antenna bay includes radiating elements of N rows and M columns. The radiating element may be a die-cast dipole, a laminated element, an air microstrip antenna, or the like. Metal walls are disposed around the radiating element, and a height of the metal wall is equal to (100%±10%) of a height of the radiating element.

Optionally, when a row spacing and a column spacing of the radiating elements are not equal, an isolating bar is disposed in the middle of a larger spacing.

Optionally, the radiating element of the antenna bay is disposed inside a cavity. The cavity may be a circular-arc cavity, a parabolic cavity, a hyperbolic cavity, or the like, to enhance secondary lobe performance of the antenna bay, and increase isolation between antenna bays.

Optionally, a fence is disposed around each antenna bay, and the fence is fully enclosed or semi-enclosed. If the fence is semi-enclosed, the fence may be disposed along two adjacent sides of the antenna bay. If the fence is fully-enclosed, the fence is disposed around all four sides of the antenna bay. A material of the fence includes an electromagnetic band gap structure EBG, a metal plate, an electromagnetic wave absorber, a left-handed material, or the like.

Optionally, an isolating wall is disposed between the two antenna bays at the two ends of the diagonal. The isolating wall is arranged horizontally, vertically, or obliquely. A material of the isolating wall includes an EBG, a metal plate, an electromagnetic wave absorber, or a left-handed material.

Optionally, symmetrical assembly slots are disposed in the metal wall of the radiating element, and are configured to assemble a radome.

Optionally, the antenna array is provided with a radome. Isolating bars of different heights are disposed inside the radome, and are configured to prevent propagation of a surface wave and a space wave of each antenna bay, and increase isolation between antenna bays.

Optionally, the antenna array is disposed on a ground plate, and a surface of the ground plate is provided with an isolating groove. The isolating groove is located in the middle of the two antenna bays at the two ends of the diagonal, and the isolating groove may be arranged horizontally, vertically, or obliquely.

Optionally, the antenna bay of the antenna array is a dual-polarized antenna, that is, each antenna bay includes two antenna channels. In a scenario in which a co-frequency co-time full duplex manner is used, each antenna bay includes two transmit channels or two receive channels. In a scenario in which an asynchronous inter-frequency manner is used, each antenna bay includes one transmit channel and one receive channel.

An example in which n=0 is used to describe this embodiment of the present invention in detail below. The antenna array includes four antenna bays: an antenna bay 1, an antenna bay 2, an antenna bay 3, and an antenna bay 4. The four antenna bays form an array of two rows and two columns. For the antenna bay 1, the antenna bay 2, the antenna bay 3, and the antenna bay 4, there is an enclosing rectangle. A line connecting center points of the antenna bay 1 and the antenna bay 2 is a part of one diagonal of the enclosing rectangle. A line connecting center points of the antenna bay 3 and the antenna bay 4 is a part of the other diagonal of the enclosing rectangle. The four antenna bays are symmetrically distributed, that is, a line connecting the center points of the antenna bay 1 and the antenna bay 4 is perpendicular to a horizontal line, a line connecting the center points of the antenna bay 1 and the antenna bay 3 is parallel to the horizontal line, a line connecting the center points of the antenna bay 2 and the antenna bay 3 is perpendicular to the horizontal line, and a line connecting the center points of the antenna bay 2 and the antenna bay 4 is parallel to the horizontal line. An angle value of an included angle between the line connecting the center points of the antenna bay 1 and the antenna bay 2 and the horizontal line falls within 30 to 60, and an angle value of an included angle between the line connecting the center points of the antenna bay 3 and the antenna bay 4 and the horizontal line falls within 30 to 60.

If the antenna array works in a scenario in which an asynchronous inter-frequency manner is used, specifically, operating frequency bands of the antenna bay 1 and the antenna bay 2 are adjacent frequency bands, and the two antenna bays transmits data in an asynchronous manner; operating frequency bands of the antenna bay 3 and the antenna bay 4 are adjacent frequency bands, and the two antenna bays transmits data in an asynchronous manner. The antenna bay 1 and the antenna bay 2 are used an example. Because the two antenna bays cannot be synchronous, when the antenna bay 1 transmits data, the antenna bay 2 may be possibly receiving data. Consequently, mutual interference on operating frequency bands is caused by leaked out-of-band signals generated by the two antenna bays during working. The leaked signal is mainly a non-linear interfering signal, and strength of the leaked signal depends on two factors: transmitter out-of-band leakage and antenna isolation.

In this embodiment of the present invention, out-of-band leakage is reduced by improving antenna isolation. A Wi-Fi scenario is used as an example. The antenna array is a Wi-Fi antenna. A value of an acute included angle between a line connecting center points of the antenna bay 1 and the antenna bay 2 and a horizontal line falls within 30 to 60. The antenna bay 1 and the antenna bay 2 are used as a first group of two-transmit and two-receive antennas of the Wi-Fi antenna. That is, the antenna bay 1 includes one transmit channel and one receive channel, and the antenna bay 2 includes one transmit channel and one receive channel. A value of an acute included angle between a line connecting center points of the antenna bay 3 and the antenna bay 4 and the horizontal line falls within 30 to 60. The antenna bay 3 and the antenna bay 4 are used as a second group of two-transmit and two-receive antennas of the Wi-Fi antenna. That is, the antenna bay 3 includes one transmit channel and one receive channel, and the antenna bay 4 includes one transmit channel and one receive channel.

If the four antenna bays work in a full duplex scenario, operating frequency bands of the antenna bay 1 and the antenna bay 2 are f1, operating frequency bands of the antenna bay 3 and the antenna bay 4 are f2, the antenna bay 1 and the antenna bay 2 transmit data in a co-frequency co-time full duplex manner, and the antenna bay 3 and the antenna bay 4 transmit data in a co-frequency co-time full duplex manner, in this way, there is quite large interference between the antenna bay 1 and the antenna bay 2, and there is quite large interference between the antenna bay 3 and the antenna bay 4. In this embodiment of the present invention, by limiting the angle value of the acute included angle between the line connecting the center points of the antenna bay 1 and the antenna bay 2 and the horizontal line and the angle value of the acute included angle between the line connecting the center points of the antenna bay 3 and the antenna bay 4 and the horizontal line to 30 to 60, isolation between the antenna bays at the two ends of the diagonal can be effectively increased, so as to reduce interference between the two antenna bays.

An embodiment of the present invention further discloses a network device. The network device may be a base station, a home gateway, a smartphone, a tablet computer, a personal digital assistant, or the like. The network device is provided with the antenna array in the embodiments of the present invention.

What is disclosed above is merely example embodiments of the present invention, and certainly is not intended to limit the protection scope of the present invention. A person of ordinary skill in the art may understand that all or some of processes that implement the foregoing embodiments and equivalent modifications made in accordance with the claims of the present invention shall fall within the scope of the present invention.

What is claimed is:

1. An antenna array, comprising:
at least two antenna bays, wherein the at least two antenna bays have same operating frequency bands, each of the at least two antenna bay comprises at least one of a transmit channel or a receive channel, and each of the at least two antenna bay transmits data in a co-frequency co-time full duplex manner; and wherein
an angle value of an acute included angle between a line connecting center points of any two adjacent antenna bays of the at least two antenna bays and a horizontal line is θ, wherein 30≤θ≤60.

2. The antenna array according to claim 1, wherein the at least two antenna bays are on a same plane.

3. The antenna array according to claim 2, wherein two adjacent antenna bays of the at least two antenna bays form a rectangle, the two adjacent antenna bays are disposed at two ends of a first diagonal of the rectangle, and a second diagonal of the rectangle is empty.

4. The antenna array according to claim 2, wherein center points of the at least two antenna bays are on a same straight line.

5. The antenna array according to claim 1, wherein each of the at least two antenna bays comprises a plurality of radiating elements, for each of the plurality of radiating element:
metal walls are disposed around the radiating element, the metal walls have a height of H, and H is equal to h*(100%±10%), wherein h is a height of the radiating element.

6. The antenna array according to claim 5, wherein a circular-arc back cavity, a parabolic back cavity, or a hyperbolic back cavity is disposed below the plurality of radiating elements of each of the at least two antenna bays.

7. The antenna array according to claim 5, wherein two symmetrical assembly slots are disposed on each vertical plane of the metal walls.

8. The antenna array according to claim 7, wherein each of the at least two antenna bays comprises radiating elements of M rows and N columns, a row spacing and a column spacing of the radiating elements of the each of the at least two antenna bay are not equal, and an isolating bar is disposed in a middle of a larger spacing.

9. The antenna array according to claim 1, wherein a fully enclosed or semi-enclosed fence is disposed around each of the at least two antenna bays, and a material of the fence comprises an electromagnetic band gap structure (EBG), a metal, an electromagnetic wave absorber, or a left-handed material.

10. The antenna array according to claim 1, wherein the at least two antenna bays share a same radome, and isolating bars of different heights are disposed inside the radome.

11. The antenna array according to claim 1, wherein the at least two antenna bays are installed on a ground plate, a surface of the ground plate is provided with an isolating groove, the isolating groove is located between two adjacent antenna bays of the at least two antenna bays, and the isolating groove is disposed horizontally, vertically, or obliquely.

12. The antenna array according to claim 1, wherein an isolating wall is disposed between two adjacent antenna bays of the at least two antenna bays, the isolating wall is arranged horizontally, vertically, or obliquely, and a material of the isolating wall comprises an EBG, a metal, an electromagnetic wave absorber, or a left-handed material.

13. The antenna array according to claim 1, wherein one of the at least two antenna bays is a dual-polarized antenna.

14. An antenna array, comprising:
at least two antenna bays, wherein the at least two antenna bays have operating frequency bands that are adjacent, separated by one frequency band, or separated by two frequency bands, each of the at least two antenna bay comprises at least one receive channel and at least one transmit channel, and each of the at least two antenna bay transmits data in an asynchronous manner; and wherein
an angle value of an acute included angle between a line connecting center points of any two adjacent antenna bays of the at least two antenna bays and a horizontal line is θ, wherein 30≤θ≤60.

15. The antenna array according to claim 14, wherein the at least two antenna bays are on a same plane.

16. The antenna array according to claim 15, wherein two adjacent antenna bays of the at least two antenna bays form a rectangle, the two adjacent antenna bays are disposed at two ends of a first diagonal of the rectangle, and a second diagonal of the rectangle is empty.

17. The antenna array according to claim 15, wherein center points of the at least two antenna bays are on a same straight line.

18. A network device, comprising:
an antenna array comprising at least two antenna bays, wherein
the at least two antenna bays have same operating frequency bands, each of the at least two antenna bay comprises at least one of a transmit channel or a receive channel, and each of the at least two antenna bay transmits data in a co-frequency co-time full duplex manner; and wherein
an angle value of an acute included angle between a line connecting center points of any two adjacent antenna bays of the at least two antenna bays and a horizontal line is θ, wherein 30≤θ≤60.

19. The network device according to claim 18, wherein the at least two antenna bays are on a same plane.

20. The network device according to claim 19, wherein two adjacent antenna bays of the at least two antenna bays form a rectangle, the two adjacent antenna bays are disposed at two ends of a first diagonal of the rectangle, and a second diagonal of the rectangle is empty.
